(19) United States
(12) Patent Application Publication
(10) Pub. No.: US 2024/0354788 A1
(43) Pub. Date: Oct. 24, 2024

(54) DEMAND PREDICTION DEVICE, DEMAND PREDICTION METHOD, AND STORAGE MEDIUM

(71) Applicant: HONDA MOTOR CO., LTD., Minato-ku, Tokyo (JP)

(72) Inventors: Satoshi Yoshimaru, Tokyo (JP); Kohei Mukaihara, Tokyo (JP)

(21) Appl. No.: 18/683,516

(22) PCT Filed: Sep. 22, 2022
(86) PCT No.: PCT/JP2022/035368

§ 371 Date: Feb. 14, 2024

(30) Foreign Application Priority Data
Sep. 28, 2021 (JP) 2021-158343

(51) Int. Cl. G06Q 30/0202; G06Q 10/20

(52) U.S. Cl. CPC G06Q 30/0202; G06Q 10/20

(57) ABSTRACT

A demand prediction device predicts a future demand for a component of a vehicle in preparation for replacement or repair of the component. The demand prediction device includes a position acquirer configured to acquire position information at an operation start time or an operation end time of the vehicle, an estimator configured to estimate a location of the vehicle on the basis of the position information acquired by the position acquirer, and a predictor configured to predict a future demand for the component in a predetermined area including the location estimated by the estimator.

### TECHNICAL FIELD

The present invention relates to a demand prediction device, a demand prediction method, and a storage medium.

Priority is claimed on Japanese Patent Application No. 2021-158343, filed Sep. 28, 2021, the content of which is incorporated herein by reference.

### BACKGROUND ART

In the related art, a technique of predicting a future demand for a component on the basis of past demand results for the component of vehicles is known (for example, see Patent Document 1).

### CITATION LIST

### Patent Document

### Patent Document 1

Japanese Unexamined Patent Application, First Publication No. 2007-199844

### SUMMARY OF INVENTION

### Technical Problem

However, in the related art, areas in which vehicles are used or operation situations of the vehicles are not considered in predicting a demand for a component of vehicles. Accordingly, a demand may not be accurately predicted due to change in demand based on relocation of users of vehicles or the like.

An aspect of the present invention was invented in consideration of the aforementioned circumstances and an objective thereof is to provide a demand prediction device, a demand prediction method, and a storage medium that can more accurately predict a future demand for components of vehicles.

### Solution to Problem

A demand prediction device, a demand prediction method, and a storage medium according to the present invention employ the following configurations.
(1) According to an aspect of the present invention, there is provided a demand prediction device that predicts a future demand for a component of a vehicle in preparation for replacement or repair of the component, the demand prediction device including: a position acquirer configured to acquire position information at an operation start time or an operation end time of the vehicle; an estimator configured to estimate a location of the vehicle on the basis of the position information acquired by the position acquirer; and a predictor configured to predict a future demand for the component in a predetermined area including the location estimated by the estimator.
(2) In the aspect of (1), the estimator may estimate the location of the vehicle on the basis of a time at which the position information is acquired by the position acquirer and the number of acquisitions.
(3) In the aspect of (2), the estimator may estimate the home or a workplace of a user of the vehicle on the basis of a time period correlated with the position information.
(4) In the aspect of (3), the estimator may estimate the home on the basis of the position information when the position information is acquired a predetermined number of times or more by the position acquirer in a first time period and estimates the workplace on the basis of the position information when the position information is acquired a predetermined number of times or more in a second time period later than the first time period.
(5) In the aspect of (1), the position acquirer may acquire the position information from each of a plurality of vehicles, the estimator may estimate a location distribution of the plurality of vehicles in a predetermined period on the basis of the position information of the plurality of vehicles, and the predictor may predict a future demand for the component for each predetermined area on the basis of the location distribution estimated by the estimator.
(6) In the aspect of (5), the demand prediction device may further include: a demand result acquirer configured to acquire demand result information of the component for each predetermined area; and an operation information acquirer configured to acquire vehicle operation information from vehicles belonging to the predetermined area, and the predictor may predict a future demand for the component for each predetermined area on the basis of tendencies of increase or decrease and fluctuation of a value based on the operation information in a time series and tendencies of increase or decrease and fluctuation of a result value based on the demand result information.
(7) In the aspect of (6), the predictor may predict the demand at a third time point later than a first time point on the basis of a result value based on the demand result information for every predetermined period in a time series and an operation value based on the operation information and on the basis of a shift between the operation value at the first time point and the operation value at a second time point earlier than the first time point.
(8) In the aspect of (7), the predictor may set a predicted value of the demand at the third time point to be lower than an existing predicted value calculated in advance when the operation value at the first time point tends to increase with respect to the operation value at the second time point and set the predicted value at the third time point to be higher than the existing predicted value calculated in advance when the operation value at the first time point tends to decrease with respect to the operation value at the second time point.
(9) According to another aspect of the present invention, there is provided a demand prediction method that is performed by a computer of a demand prediction device for predicting a future demand for a component of a vehicle in preparation for replacement or repair of the component, the demand prediction method including: acquiring position information at an operation start time or an operation end time of the vehicle; estimating a location of the vehicle on the basis of the acquired position information; and predicting a future demand for the component in a predetermined area including the estimated location.
(10) According to another aspect of the present invention, there is provided a storage medium storing a program, the program causing a computer of a demand prediction device for predicting a future demand for a component of a vehicle in preparation for replacement or repair of the component to perform: acquiring position information at an operation start time or an operation end time of the vehicle; estimating a location of the vehicle on the basis of the acquired position information; and predicting a future demand for the component in a predetermined area including the estimated location.

### Advantageous Effects of Invention

According to the aspects of (1) to (10), it is possible to more accurately predict a future demand for components of vehicles.

### BRIEF DESCRIPTION OF DRAWINGS

FIG. 1 is a diagram illustrating an example of a configuration of a demand prediction system 1 including a demand prediction device according to an embodiment.

FIG. 2 is a diagram illustrating an example of a functional configuration of a vehicle system 10 that is mounted in a vehicle M.

FIG. 3 is a diagram illustrating an example of a functional configuration of a demand prediction device 100.

FIG. 4 is a diagram illustrating an example of details of operation information 181.

FIG. 5 is a diagram illustrating an example of details of demand result information 182.

FIG. 6 is a diagram illustrating estimation of a location of a vehicle M.

FIG. 7 is a diagram illustrating estimation of an area to which a location of a vehicle M belongs.

FIG. 8 is a diagram illustrating subareas based on latitude and longitude.

FIG. 9 is a diagram illustrating a result of collection of some operation information for each combination of a vehicle model and an area.

FIG. 10 is a diagram illustrating actual travel state information.

FIG. 11 is a diagram illustrating comparison between actual travel state information and demand result information 182.

FIG. 12 is a (first) diagram illustrating a process of generating prediction information.

FIG. 13 is a (second) diagram illustrating a process of generating prediction information.

FIG. 14 is a flowchart illustrating an example of a process flow that is performed by the demand prediction device 100.

FIG. 15 is a flowchart illustrating an example of a process flow that is performed by a predictor 160.

### DESCRIPTION OF EMBODIMENTS

Hereinafter, a demand prediction device, a demand prediction method, and a storage medium according to an embodiment of the present invention will be described with reference to the accompanying drawings.

### Entire Configuration

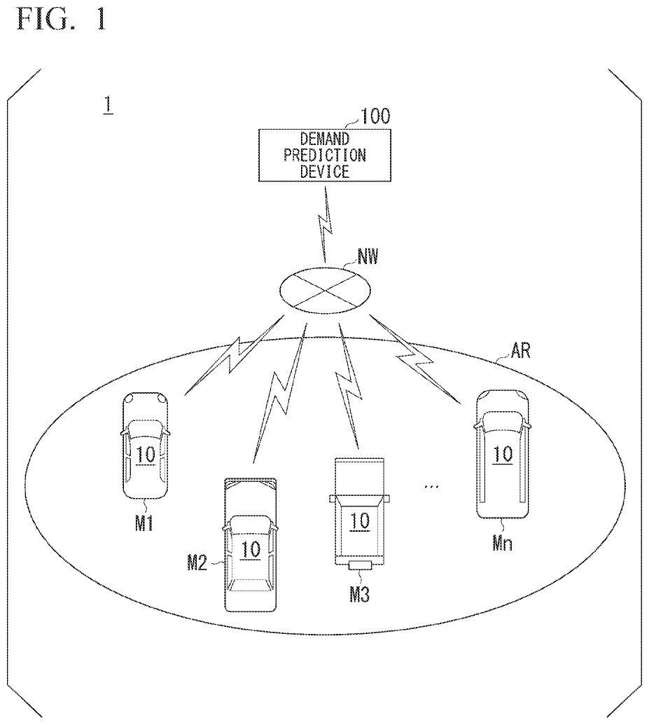

FIG. 1 is a diagram illustrating an example of a configuration of a demand prediction system 1 including a demand prediction device according to an embodiment. The demand prediction system 1 includes, for example, one or more vehicles M1 to Mn and a demand prediction device 100. In the following description the vehicles M1 to Mn are referred to as “vehicles M” when they are not particularly distinguished. A vehicle M is a vehicle with two wheels, a vehicle with three wheels, or a vehicle with four wheels, and a drive source thereof is an internal combustion engine such as a diesel engine or a gasoline engine, an electric motor, or a combination thereof. The electric motor operates using electric power generated by a power generator connected to the internal combustion engine or electric power discharged from a secondary battery or a fuel cell. In the following description, it is assumed that each vehicle M is a vehicle with four wheels. Each vehicle M and a demand prediction device 100 can communicate with each other via a network NW. The network NW includes the Internet, a wide area network (WAN), a local area network (LAN), a public line, a provider device, a private line, and a wireless base station. The demand prediction device 100 predicts a future demand for components in preparation for replacement or repair of the components of vehicles M on the basis of information acquired from the vehicles M via the network NW. Examples of the components include various components such as an engine, a vehicle body, a drive train (a transmission or a drive shaft), and a chassis (a suspension, a steering wheel, tires, and wheels) and various products associated with a vehicle such as a car navigation device, a drive recorder, audio equipment, onboard devices such as various sensors, seats in a cabin, interior components such as illuminations, a brake pad, and an engine oil. Each vehicle M and the demand prediction device 100 will be specifically described below.

### Vehicle

Each vehicle M is, for example, a vehicle that is used in a predetermined area AR. The predetermined area AR may be a partitioned region for each country, each local area, or each district or may be an area which is partitioned on the basis of map coordinates such as latitude and longitude. The predetermined area AR includes, for example, an area in which the vehicle M is mainly used or an area corresponding to a parking space of the vehicle M. A vehicle system 10 that acquires various types of information on the vehicle M from various sensors or onboard devices mounted in the vehicle M or communicates with the demand prediction device 100 is mounted in the vehicle M.

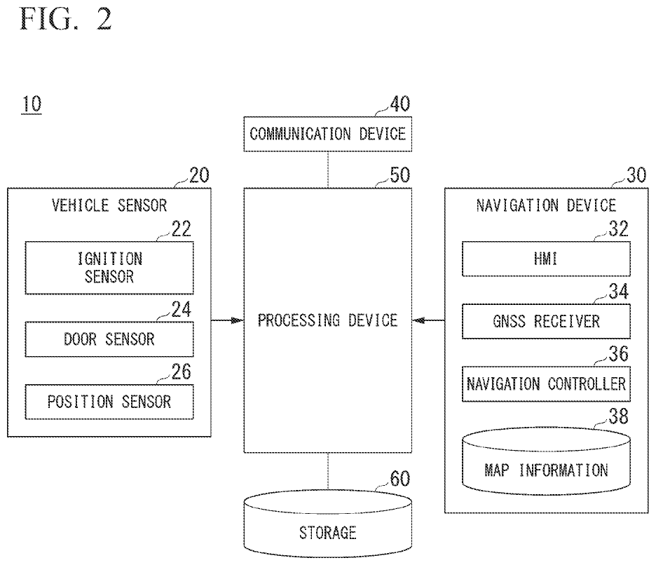

FIG. 2 is a diagram illustrating an example of a functional configuration of the vehicle system 10 mounted in a vehicle M. The vehicle system 10 includes, for example, a vehicle sensor 20, a navigation device 30, a communication device 40, a processing device 50, and a storage 60. The vehicle system 10 includes actuators, electronic devices, and operators for controlling the vehicle which are not illustrated in addition to the aforementioned functional constituents.

The vehicle sensor 20 includes, for example, an ignition sensor 22, a door sensor 24, and a position sensor 26. The ignition sensor 22 detects an on state or an off state of an ignitions witch for starting or ending the operation of the vehicle M (for example, driving of an engine). The ignition sensor 22 may detect switching of the ignition switch from the off state to the on state or switching of the ignition switch from the on state to the off state. The door sensor 24 detects opening or closing of a door of the vehicle M when a user boards the vehicle M or alights from the vehicle M. When a plurality of doors are provided in the vehicle M, the door sensor 24 may detect opening or closing of a specific door such as a door for getting on a driver's seat (or getting out of the driver's seat) of the vehicle M. The position sensor 26 is, for example, a sensor that acquires position information (for example, longitude and latitude information) of the vehicle M from a global positioning system (GPS) device. The position sensor 26 may be a sensor that acquires the position information using a global navigation satellite system (GNSS) receiver 34 of the navigation device 30. The vehicle sensor 20 may include a sensor that detects a signal (a radio signal) from a smart keying system (not illustrated) that enables a key switch of the vehicle M to be operated in a keyless state.

The vehicle sensor 20 may include a vehicle speed sensor that detects a speed of the vehicle M, an acceleration sensor that detects acceleration, and a yaw rate sensor that detects a yaw rate (for example, a rotational angular velocity around a vertical axis passing through the center of gravity of the vehicle M), and a direction sensor that detects a direction of the vehicle M. The vehicle sensor 20 may include, for example, a brake pedal sensor that detects an operation performed on a brake pedal or a steering sensor that detects an amount of steering (for example, a steering angle) of the vehicle M. Results detected by the vehicle sensor 20 are output to the processing device 50.

The navigation device 30 includes, for example, a human-machine interface (HMI) 32, a GNSS receiver 34, a navigation controller 36, and map information 38. The HMI 32 includes, for example, a touch-panel display device, a speaker, and a microphone. The GNSS receiver 34 measures a self-position (for example, a position of the vehicle M) on the basis of radio waves transmitted from GNSS satellites (for example, GPS satellites). The navigation device 30 may has a function of acquiring the position of the vehicle M from the position sensor 26 in place of the GNSS receiver 34. The navigation controller 36 includes, for example, a central processing unit (CPU) and various storage devices and controls the navigation device 30 as a whole. Map information (navigation map) 38 is stored in the storage device. The map information 38 is, for example, a map in which roads are expressed by nodes and links. The map information 38 may include various types of road information such as curvatures or the number of lanes of roads, road widths, speed limits, and traffic regulation information and point of interest (POI) information. The POI information includes, for example, regional information (a country, a region, and a district), address information (addresses and post codes), facility information, and information of phone numbers correlated with position information (latitude and longitude). The facility information includes, for example, predetermined facilities that manage stock, forwarding, production, and the like of components in addition to buildings and parking lots. The predetermined facilities may include, for example, a maintenance factory that performs replacement or repair of components of vehicles M, warehouses that store components of vehicles M, and companies (for example, dealers) such as vehicle manufacturers that manufacture and sell vehicles M. The map information 38 may be updated from time to time by allowing the communication device 40 to communicate with another device. For example, the navigation controller 36 extracts a route from the current position (a point of the position information) of the vehicle M to a destination set by an occupant with reference to the map information 38 on the basis of the destination and the position information acquired from the position sensor 26 or the GNSS receiver 34 and outputs the extracted route to the HMI 32.

The communication device 40 is, for example, a communication interface for communication with the demand prediction device 100 or another external device via the network NW. The communication device 40 perform wireless communication on the basis of communication protocols such as Wi-Fi, Dedicated Short Range Communications (DSRC), and Bluetooth (registered trademark).

The processing device 50 is realized by causing a hardware processor such as a CPU to execute a program (software) stored in the storage device. The processing device 50 is realized, for example, by causing a hardware processor such as a CPU to execute a program (software). Some or all of these functional constituents may be realized by hardware (a circuit part including circuitry) such as a large scale integration (LSI) circuit, an application-specific integrated circuit (ASIC), a field-programmable gate array (FPGA), or a graphics processing unit (GPU) or may be cooperatively realized by software and hardware. The program may be stored in a storage device (a storage device including a non-transitory storage medium) such as an HDD or a flash memory of the vehicle system 10 in advance or may be stored in a detachable storage medium such as a DVD or a CD-ROM and installed in the HDD or the flash memory of the vehicle system 10 by setting the storage medium (a non-transitory storage medium) into a drive device. The storage 60 may be realized, for example, by the aforementioned storage devices or a solid state drive (SSD), a random access memory (RAM), or a hard disc drive (HDD). For example, information output from the vehicle sensor 20 or information supplied from the navigation device 30 is stored in the storage 60.

The processing device 50 provides operation information associated with operation of the vehicle M including information detected by the vehicle sensor 20 or information supplied from the navigation device 30 to the demand prediction device 100. The operation information includes, for example, position information of the vehicle M or information indicating an actual travel state. The information indicating an actual travel state of the vehicle M includes, for example, at least one of a travel time of the vehicle M, a travel distance of the vehicle M, the number of braking times, a degree of braking, a degree of sudden acceleration (the number of times), a degree of sudden deceleration (the number of times), and the number of times of change of the lateral acceleration of the vehicle M by a predetermined degree or more (the number of sudden turns). The operation information may include an operation start time, an operation start point, an operation end time, and operation end point. For example, the processing device 50 sets a time at which the ignition sensor 22 has detected that the ignition switch of the vehicle M is switched to the on state as the operation start time and sets the position information of the vehicle M at that time as the operation start point. The operation start time may be, for example, a time at which the door sensor 24 has detected that the door is opened by a user of the vehicle M to get in a driver's seat or may be a time at which a signal for starting the engine from the smart keying system has been detected. For example, the processing device 50 sets a time at which the ignition sensor 22 has detected that the ignition switch of the vehicle M is switched to the off state as the operation end time and sets the position information of the vehicle M at that time as the operation end point. The operation end time may be, for example, a time at which the door sensor 24 has detected that the door is opened by a user of the vehicle M to alight from the driver's seat or may be a time at which a signal for stopping the engine from the smart keying system has been detected. Instead of generating and transmitting the operation information, the processing device 50 may provide original data (connected data) for causing the demand prediction device 100 to generate operation information (operation information 181 which will be described later) to the demand prediction device 100.

### Demand Prediction Device

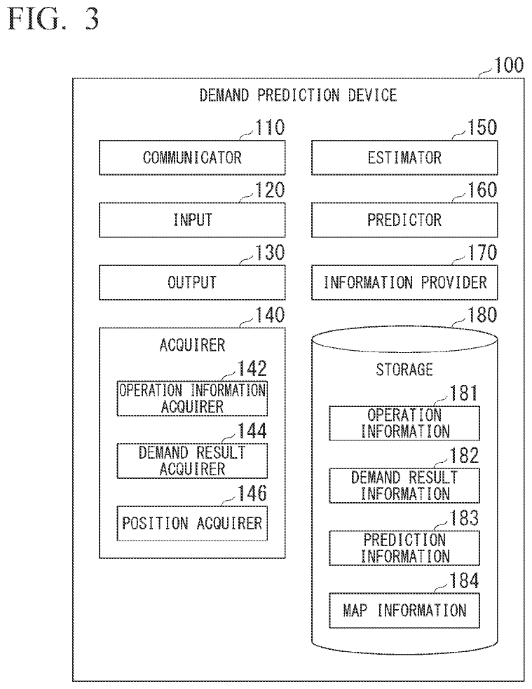

FIG. 3 is a diagram illustrating an example of a functional configuration of the demand prediction device 100. The demand prediction device 100 includes, for example, a communicator 110, an input 120, an output 130, an acquirer 140, an estimator 150, a predictor 160, an information provider 170, and a storage 180. The acquirer 140, the estimator 150, the predictor 160, and the information provider 170 are realized, for example, by causing a hardware processor such as a CPU to execute a program (software). Some or all of these functional constituents may be realized by hardware (a circuit part including circuitry) such as an LSI, an ASIC, an FPGA, or a GPU or may be cooperatively realized by software and hardware. The program may be stored in a storage device (a storage device including a non-transitory storage medium) such as an HDD or a flash memory of the demand prediction device 100 in advance or may be stored in a detachable storage medium such as a DVD or a CD-ROM and installed in the HDD or the flash memory of the demand prediction device 100 by setting the storage medium (a non-transitory storage medium) into a drive device.

The storage 180 is realized, for example, by the aforementioned storage devices, an SSD, a RAM, or an HDD. For example, operation information 181, demand result information 182, prediction information 183, and map information 184 are stored in the storage 180. The program executed by the processor of the demand prediction device 100 or various types of other information may be stored in the storage 180. The operation information 181 is operation information acquired from vehicles via the network NW. The demand result information 182 is information on demand results of components for a predetermined area. The demand result information 182 is acquired, for example, from a predetermined facility (for example, a dealer) or a management device (an example of an external device which is not illustrated) managing demand results via the network NW. The prediction information 183 is a future demand prediction result of components of the vehicles M which is predicted by the predictor 160 which will be described later. The map information 184 is, for example, the same information as the map information 38. As the map information 184, map information of an area broader than the map information 38 may be stored. The map information 184 may be updated from time to time by causing the communicator 110 to communicate with another device.

The communicator 110 includes, for example, a communication interface such as a network interface card (NIC) or a wireless communication antenna. The communicator 110 communicates with vehicles M via the network NW under the control of another constituent.

The input 120 includes, for example, some or all of various keys, buttons, switches, and a mouse and receives an input from a user of the demand prediction device 100 or the like. The output 130 includes, for example, various display devices such as a liquid crystal display (LCD) or an electroluminescence (EL) display, a speaker, or a projector. The display device of the output 130 may be integrally formed with the input 120 such as a touch panel.

The acquirer 140 includes, for example, an operation information acquirer 142 and a demand result acquirer 144. The operation information acquirer 142 acquires operation information from vehicles M via the network NW. The operation information acquirer 142 stores the operation information acquired from the vehicles M1 to Mn as operation information 181 for each vehicle M in the storage 180.

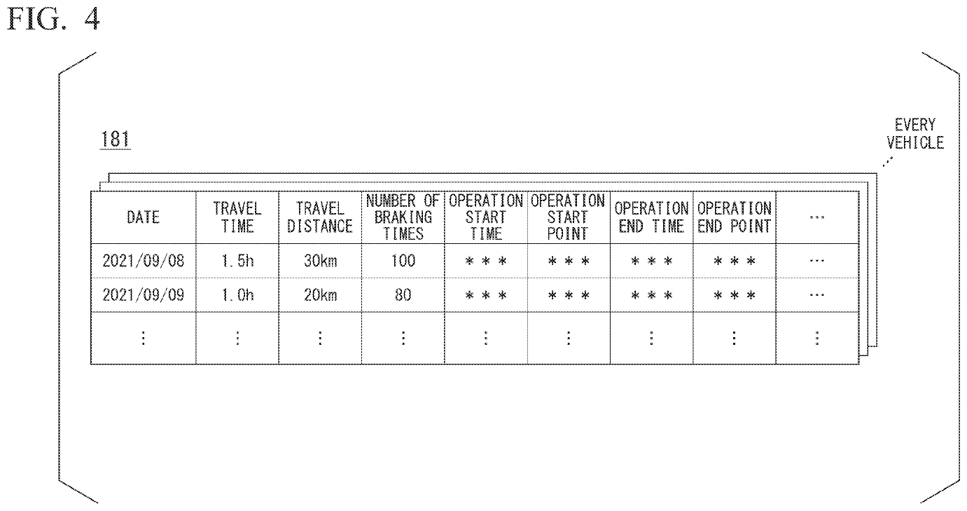

FIG. 4 is a diagram illustrating an example of details of the operation information 181. The operation information 181 is information in which a date (or a date and time) and information indicating an operation situation of a vehicle M are correlated for each vehicle M. The information indicating an operation situation is, for example, information indicating an operation state or a travel state of a vehicle M such as a travel time, a travel distance, the number of braking times, an operation start time, an operation start point, an operation end time, and an operation end point. The travel time may be, for example, a time until the ignition switch of the vehicle M is switched to the off state after the ignition switch has been turned on or a time in which the vehicle M is traveling actually at a predetermined speed or higher. The number of braking times is the number of braking operations or the number of times a braking operation of a predetermined degree or higher has been performed. The operation situation may include the number of times acceleration or deceleration has changed by a predetermined degree or more (the number of times of sudden acceleration or sudden deceleration) or the number of times lateral acceleration of the vehicle M has changed by a predetermined degree or more (the number of sudden turns).

Information included in the operation information 181 may be generated by the processing device 50 of the vehicles M or may be generated by the operation information acquirer 142 using information for generating the operation information 181 (original connected data) acquired from the vehicles M.

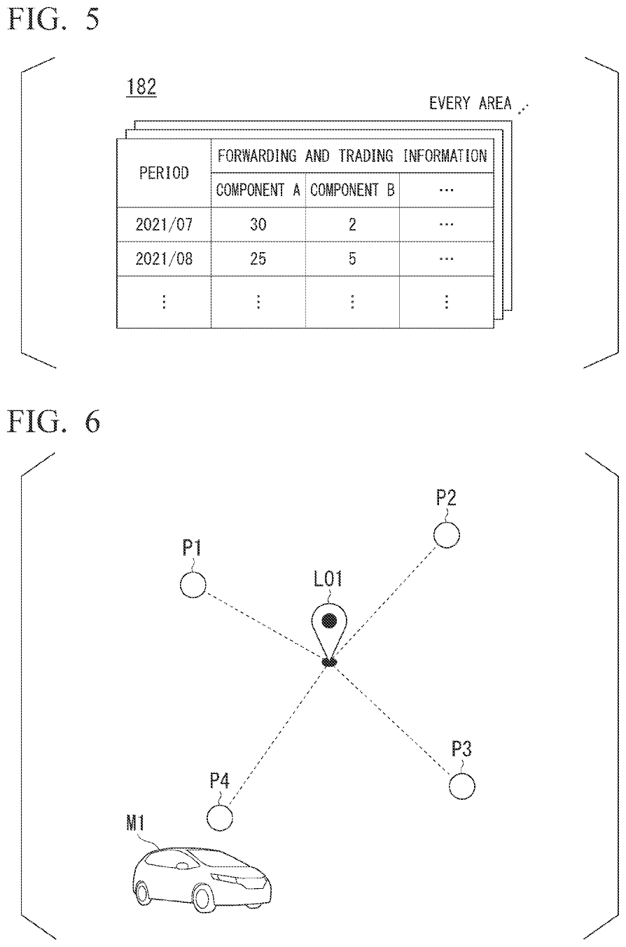

The demand result acquirer 144 acquires past demand results for components of the vehicles M, for example, from one or more predetermined facilities managing stock, forwarding, production, and the like of components, a management device managing demand results, or the like via the network NW. The demand result acquirer 144 stores the acquired demand result information 182 in the storage 180. FIG. 5 is a diagram illustrating an example of details of the demand result information 182. The demand result information 182 is information in which a period and forwarding and selling information are correlated for each area including the predetermined facility. The demand result information 182 may be collected for each vehicle model in addition to (or instead of) the areas. The period is a predetermined period such as two weeks, one month, or three months. As the forwarding and selling information, for example, the number of components forward or sold is stored for each component of the vehicles M. In the demand result information 182, the number of times components are replaced or repaired may be stored instead of (or in addition to) the forwarding and selling information.

A position acquirer 146 acquires position information of a vehicle M when the ignition switch is switched from the off sate to the on state or position information of a vehicle M when the ignition switch is switched from the on state to the off state on the basis of the operation information 181 acquired by the operation information acquirer 142.

The estimator 150 estimates a location of each vehicle M on the basis of the position information acquired by the position acquirer 146. The location is, for example, a headquarters (a base) of activities of the corresponding vehicle M and is more specifically the home or a workplace of a user of the vehicle M.

FIG. 6 is a diagram illustrating estimation of a location of a vehicle M. For example, when a location LO1 of a certain vehicle M1 is estimated, the estimator 150 acquires position information (an operation start point) when the ignition switch is switched to the on state (at the time of start of an operation) or position information (an operation end point) when the ignition switch is switched to the off state (at the time of end of an operation) which is included in the operation information 181 in a predetermined period. Then, the estimator 150 estimates a central point of the points (the operation start point and the operation end point) acquired in the predetermined period as the location of the vehicle M. In the example illustrated in FIG. 4, when the position information at the time of ignition-on of the vehicle M1 includes points P1 to P4, a central point thereof is estimated as the location LO1. The central point is derived, for example, using an average value of the latitude and an average value of the longitude of the points P1 to P4.

For example, when at least one point (for example, the point P1) out of the points P1 to P4 is separated from the other points (for example, the points P2 to P4) by a predetermined distance or more, the estimator 150 may estimate the location except for the point. The estimator 150 may estimate the location of the vehicle M on the basis of the time (the operation start time and the operation end time) at which the position information has been acquired and the number of times of acquisition. In this case, for example, when position information when the ignition switch is switched to the on state has been detected five times or more per month, the estimator 150 estimates the location of the vehicle M. The estimator 150 may estimate a vehicle M of which position information (the operation start point) has been acquired a predetermined number of times in a predetermined period as an operational vehicle and estimate a vehicle M of which position information has been acquired by less than the predetermined number of times as a non-operational vehicle. Accordingly, it is possible to predict demand with higher accuracy using operation information of vehicles with high operation rates.

The estimator 150 may estimate locations for each vehicle model on the basis of vehicle model information of the vehicles M included in the operation information instead of (or in addition to) the aforementioned estimation method. Accordingly, it is possible to predict a demand on the basis of locations for each vehicle model. Since position information of different vehicles M can be acquired a predetermined number of times or more in a predetermined period on the basis of the position information of vehicle models, it is possible to estimate more locations of the vehicles M.

The estimator 150 may estimate whether a location is the home or a workplace of a user of a vehicle M on the basis of a time period in which the position information is acquired. For example, the user is likely to depart (go to work) from the home using the vehicle M when the time in which the position information is acquired (for example, the operation start time) is in a first time period (for example, 07:00 to 09:00) corresponding to the morning, and the user is likely to return home from a workplace (an office) using the vehicle M when the time in which the position information is acquired is in a second time period (for example, 18:00 to 20:00) corresponding to the night. Accordingly, the estimator 150 estimates the location estimated on the basis of the position information acquired in the first time period as the home of the user of the vehicle M and estimates the location estimated on the basis of the position information acquired in the second time period (a time period later than the first time period) as the workplace of the user of the vehicle M. Accordingly, since the location can be more specifically ascertained and different demand predictions can be performed in the home, the workplace, and other locations, it is possible to predict a demand in more detail.

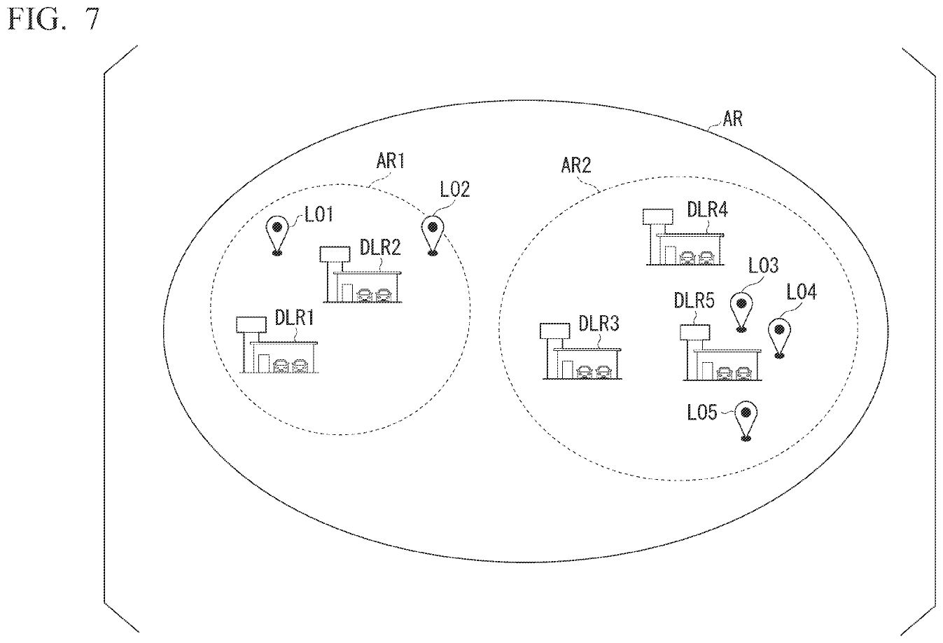

The estimator 150 estimates to what area on a map the location of the vehicle M belongs on the basis of the estimated location of the vehicle M and the map information 184 stored in the storage 180. FIG. 7 is a diagram illustrating estimation of an area to which a location of a vehicle M belongs. In the example illustrated in FIG. 7, it is assumed that two subareas AR1 and AR2 included in a predetermined area AR on a map are set. For example, when the area AR is a country, the subareas AR1 and AR2 represent different regions. When the area AR is a region, the subareas AR1 and AR2 represent different maps. The subareas AR1 and AR2 may be set, for example, on the basis of positions of predetermined facilities present in the area AR. The subareas AR1 and AR2 are set, for example, to correspond to areas included in the demand result information 182. The subareas AR1 and AR2 may be arbitrarily set by a user or the like through the input 120.

In the example illustrated in FIG. 7, a subarea AR1 including dealers DLR1 and DLR2 and a subarea AR2 including dealers DLR3 to DLR5 are set on the basis of position information of five dealers (an example of predetermined facilities) in the area AR.

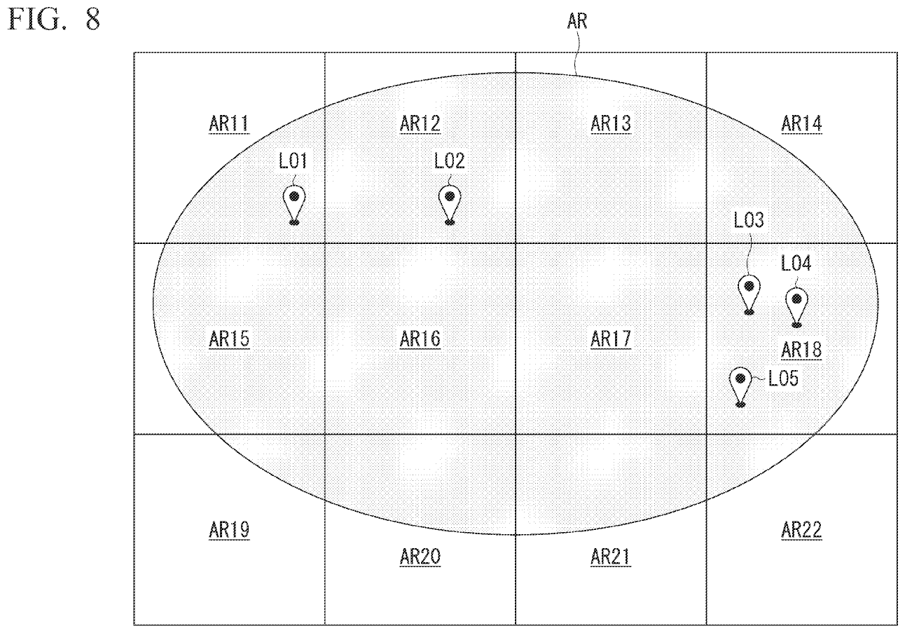

The subareas may be areas which are set with respect to the latitude and longitude of the area AR on the basis of the map information 184. FIG. 8 is a diagram illustrating subareas with respect to the latitude and longitude. In the example illustrated in FIG. 8, a plurality of subareas AR11 to AR22 are set with respect to the latitude and longitude such that subareas cover the whole area AR.

The estimator 150 estimates to what subarea each vehicle belongs out of the set subareas. The location LO1 in FIGS. 7 and 8 indicates a point which is estimated to be a location of a vehicle M1 (for example, the home). Similarly, locations LO2 to LO5 indicate points which are estimated to be locations (for example, the home) of the vehicles M2 to M5. In the example illustrated in FIG. 7, the estimator 150 estimates that the vehicle M1 and the vehicle M2 belong to the subarea AR1 and the vehicles M3 to M5 belong to the subarea AR2 on the basis of the locations LO1 to LO5 of the vehicles M1 to M5 and the positions of the subareas AR1 and AR2. In the example illustrated in FIG. 8, the estimator 150 estimates that the vehicle M1 belongs to the subarea AR11, the vehicle M2 belongs to the subarea AR12, and the vehicles M3 to M5 belong to the subarea AR18 on the basis of the locations LO1 to LO5 of the vehicles M1 to M5 and the positions of the subareas AR11 and AR22. Accordingly, a location distribution of vehicles M indicating to what subarea each of a plurality of vehicles belongs can be ascertained for each subarea.

The predictor 160 predicts a future demand (for example, after a predetermined time elapses such as after two weeks, after one month, or after three months) for a component of vehicles M in a predetermined area (subarea) including locations identified by the estimator 150. The predictor 160 stores the predicted details as prediction information 183 in the storage 180. The prediction information 183 may include results predicted in the past. Details of the function of the predictor 160 will be described later.

The information provider 170 generates provision information to be provided to an external device (for example, a predetermined facility) on the basis of the prediction information 183 and provides the generated provision information to the external device via the network NW. The external device is, for example, a terminal device of a company or a department managing components or a terminal device of a predetermined facility of a company or a department manufacturing components. The information provider 170 may provide the provision information to a user of the demand prediction device 100 by causing the output 130 to output the provision information. Accordingly, it is possible to more appropriately perform inventory management of components on the basis of the demand prediction for each subarea, to curb stock-out, operator shortage, or the like in the facilities belonging to each subarea, and to provide a batter service without causing users of vehicles M to wait.

### Function of Predictor

Details of the function of the predictor 160 will be described below. The predictor 160 predicts a demand for a component for each subarea on the basis of the operation information 181 and the demand result information 182. The predictor 160 may predict a future demand for each vehicle model of vehicles M (or for each group of specific vehicle models), for each component, or for each combination of a vehicle model and a component in addition to (or instead of) each subarea. In this case, the predictor 160 may collect (re-collect) the operation information 181 or the demand result information 182 according to a prediction target.

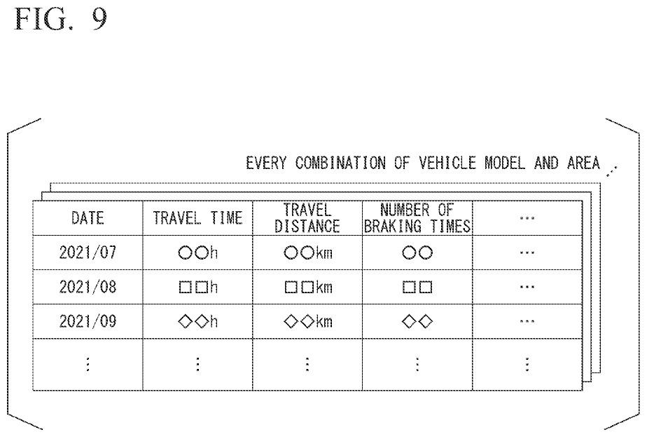

FIG. 9 is a diagram illustrating results of collection of a part of operation information for each combination of a vehicle model and an area. In the example illustrated in FIG. 9, results of collection of a part of the operation information 181 every predetermined period are illustrated for each combination of vehicles of the same vehicle model and vehicles belonging to the same subarea. The predetermined period is a period which is arbitrarily determined such as a month or a week. The subarea to which a vehicle belongs is an area to which a vehicle M belongs and which is estimated by the estimator 150 on the basis of the location of the vehicle M. The results of collection illustrated in FIG. 9 are, for example, information including a travel time, a travel distance, the number of times of braking, or the like of vehicles M of a vehicle model a belonging to an area A very month.

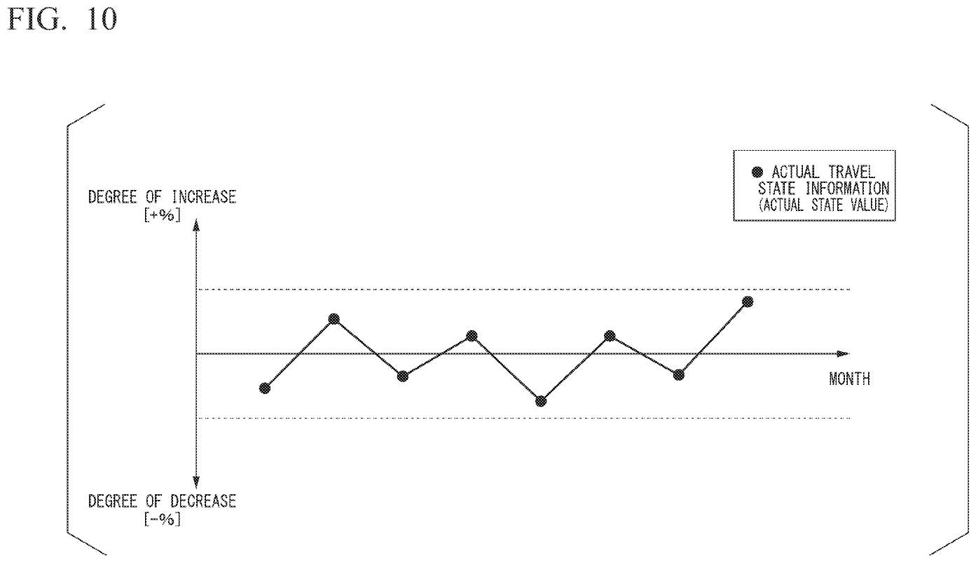

The predictor 160 generates actual travel state information on the basis of the aforementioned results of collection. The results of collection or the actual travel state information is an example of “information indicating actual travel states of vehicles correlated with a predetermined area.” FIG. 10 is a diagram illustrating the actual travel state information. The actual travel state information is, for example, information indicating actual travel states of vehicles M for each area and each vehicle model acquired from the aforementioned results of collection. For example, the actual travel state information is information indicating increase or decrease of predetermined items (such as the travel time, the travel distance, and the number of times of braking) in the collection information every predetermined period. The actual travel state information may be information generated with attention to an arbitrary item out of the items (such as the travel time, the travel distance, and the number of times of braking) in the collection information or may be information generated with attention to all the items. The actual travel state information may be information acquired by scoring an arbitrary item.

In the example illustrated in FIG. 10, actual travel state information generated with attention to the travel time (an actual state value) in the results of collection. In the actual travel state information illustrated in FIG. 10, a degree of increase and a degree of decrease of the travel time of a vehicle M every month are illustrated. As illustrated in FIG. 10, the travel time of a vehicle M tends to alternately increase and decrease, and the fluctuation widths of increase and decrease tend to be in a predetermined range.

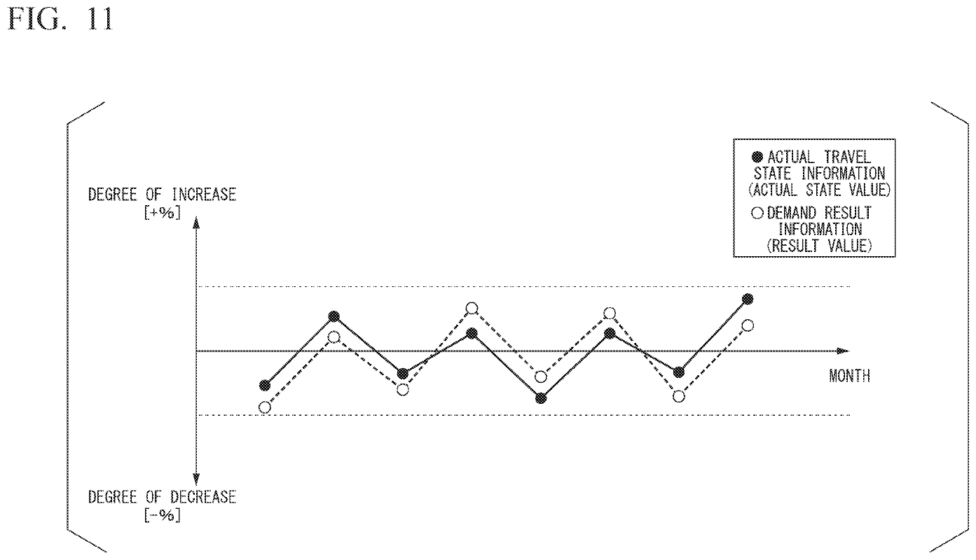

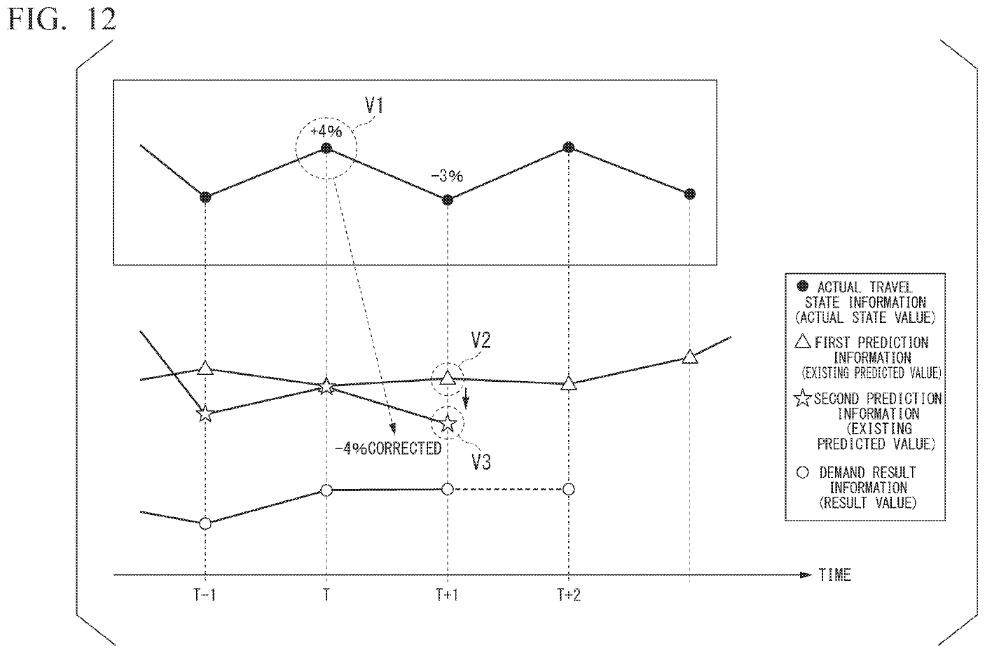

Then, the predictor 160 compares the actual travel state information with the demand result information 182. FIG. 11 is a diagram illustrating comparison between the actual travel state information and the demand result information 182. In the example illustrated in FIG. 11, demand result information (a result value) on the number of times of replacement or repair of a predetermined component in the demand result information in the same area as the area when the actual travel state information is generated is illustrated every month. In the example illustrated in FIG. 11, the result value is scored in a different numerical value by normalizing the numerical value of the result value such that comparison with the actual travel state information is facilitated. Comparison items between the actual travel state information and the demand result information are items which are correlated according to traveling or usage of the vehicles M. For example, in the example illustrated in FIG. 11, when the item in the actual travel state information is the number of times of braking, an item (component) in the demand result information is a brake pad.

As illustrated in FIG. 11, a tendency of increase or decrease in the demand result information (a result value) indicating the number of components actually forwarded in a time series and a tendency of increase or decrease in the actual travel state information are equal or similar to each other. A tendency of fluctuation in the demand result information (the result value) indicating the number of components actually forwarded and a tendency of fluctuation in the actual travel state information are equal or similar to each other. The increase or decrease of the travel time of vehicles M for each month and the increase or decrease of the number of components forwarded for each month interlink with each other (feature 1), and the fluctuation of the travel time of vehicles M for each month and the fluctuation of the number of components forwarded for each month interlink with each other (feature 2).

The predictor 160 more accurately predicts a demand for a component using the tendencies of the actual travel states (feature 1 and feature 2) indicated by the result information and the actual travel state information. The predictor 160 generates prediction information indicating the predicted demand for the component (information indicating an existing predicted value) predicted on the basis of various indices on the basis of the actual travel state information and the demand result information. For example, the predictor 160 generates prediction information on the basis of tendencies of demand such as the number of components forwarded (or the number of times of replacement or repair) up to the current time included in the demand result information 182 and various economic indicators. The economic indicators include, for example, a gross domestic product (GDP), an industrial production index, and the number of orders for machinery. The predictor 160 may generate prediction information for each predetermined area on the basis of variations of the number of vehicles, seasonal variations, trend variations, travel time variations, and braking variations for each area based on the location distribution. In this way, by generating the prediction information for each area, for example, it is possible to more accurately predict a demand according to change of a demand, change of a travel environment, or change in a location distribution due to relocation of users of vehicles M.

FIG. 12 is a (first) diagram illustrating a process of generating prediction information. The predictor 160 predicts a demand for a component using result values and indices of actual travel state information every predetermined period which are result values and indices at three or more time points. For example, the predictor 160 predicts a demand for the component at time T+1 using indices of the actual travel state information at times T−1 and T and predicts a demand for the component at time T+2 using indicates of the actual travel state information at times T and T+1.

The predictor 160 predicts a demand at time T+1 (an example of a “third time point” later than a first time point) on the basis of a shift of an index of the actual travel state information at time T−1 (an example of a “second time point” earlier than the first time point) with respect to the index of the actual travel state information at time T (an example of the “first time point”). For example, when the index of the actual travel state information at time T tends to increase with respect to the index of the actual travel state information at time T−1, the predictor 160 sets a predicted value of a demand at time T+1 to be lower than the existing predicted value. When the index of the actual travel state information at time T tends to decrease with respect to the index of the actual travel state information at time T−1, the predictor 160 sets the predicted value of a demand at time T+1 to be higher than the existing predicted value.

When the index of the actual travel state information at time T tends to increase with respect to the index of the actual travel state information at time T−1, the predictor 160 predicts a demand at time T+1 on the basis of a value obtained by subtracting a magnitude of a difference between the index of the actual travel state information at time T and the index of the actual travel state information at time T−1 from the existing predicted value at time T+1. For example, when the index of the actual travel state information at time T tends to decrease with respect to the index of the actual travel state information at time T−1, the predictor 160 predicts a demand at time T+1 on the basis of a value obtained by adding a magnitude of a difference between the index of the actual travel state information at time T and the index of the actual travel state information at time T−1 to the existing predicted value at time T+1.

The process of acquiring prediction information at time T+1 when the current time is time T will be specifically described below. The predictor 160 generates prediction information in which a value obtained by decreasing the existing predicted value at a next time T+1 (V2 in FIG. 12) by 4% is set as a new predicted value (V3 in FIG. 12) because the actual travel state value (V1 in FIG. 12) of the actual travel state information at time T is larger by 4% than the actual travel state value in the actual travel state information at time T−1. The predictor 160 predicts that there is a tendency of decrease after the demand has increased using feature 1 and predicts that the demand decreases by the degree of increase because the fluctuation has the same tendency using feature 2.

Instead of setting a value obtained by decreasing the existing predicted value by 4% as a new predicted value, a value obtained by applying a difference between the actual travel state value at time T and the actual travel state value at time T−1 to a function or a value calculated using a coefficient may be set as a new predicted value. Instead of the values, tendencies such as the tendency of increase or the tendency of decrease with respect to the existing predicted value may be calculated through the aforementioned process.

As described above, when the actual travel state value at a time of interest tends to increase with respect to that at a previous time, the predictor 160 predicts a new predicted value by correcting the existing predicted value on the basis of the actual travel state value having the tendency of increase. Accordingly, the demand prediction device 100 can more accurately predict a demand for a component for each area.

When the actual travel state value at a time of interest tends to decrease with respect to that at a previous time, the predictor 160 predicts a new predicted value by correcting the existing predicted value on the basis of the actual travel state value having the tendency of decrease. Accordingly, the demand prediction device 100 can more accurately predict demand for components.

In this way, the predictor 160 can more accurately predict a demand for a component by calculating a new predicted value by correcting the existing predicted value at a next time on the basis of characteristics in which the actual travel state value at a next time has a tendency opposite to the tendency of increase or decrease of the actual travel state value in the past (an operation value at a first time point and an operation value at a second time point) and the existing predicted value at the next time.

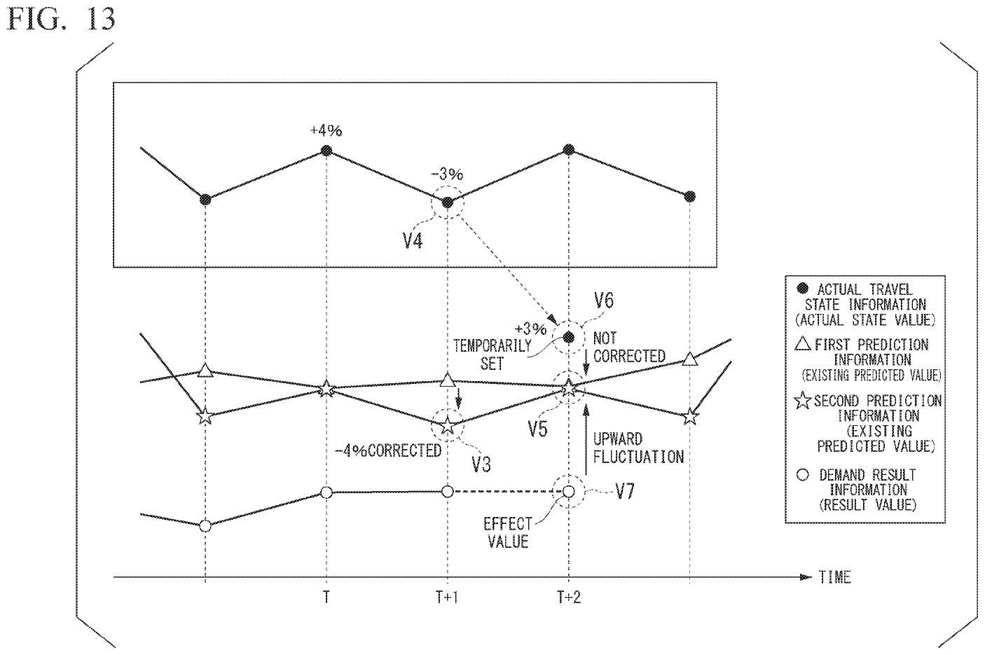

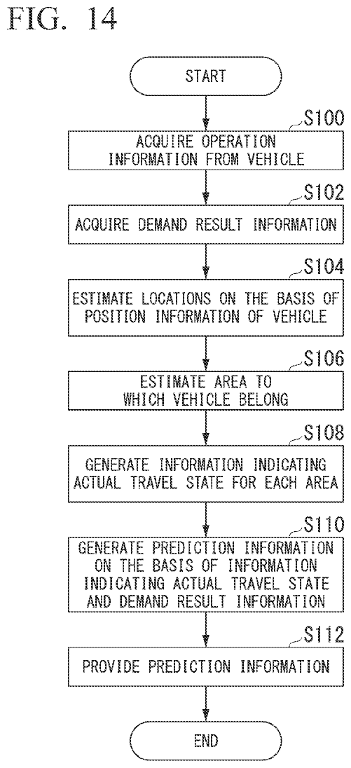

FIG. 13 is a (second) diagram illustrating the process of generating prediction information. The predictor 160 predicts future demand for components on the basis of demand result information, an actual travel state value, and an existing predicted value. The predictor 160 predicts a demand on the basis of a relative relationship between an index acquired from the actual travel state value, the existing predicted value, and an index acquired from the result value. For example, the predictor 160 determines whether the existing predicted value is to be employed as a predicted value or whether a value obtained by correcting the existing predicted value is to be employed as a predicted value on the basis of the relative relationship between the index acquired from the actual travel state value, the existing predicted value, and the index acquired from the result value.

The process of acquiring prediction information at time T+2 when the current time is time T+1 will be described below. The predictor 160 temporarily sets a value obtained by increasing the existing predicted value at a next time T+2 (V5 in FIG. 13) by 3% as a new predicted value at a next time T+2 (V6 in FIG. 13) because the actual travel state value (V4 in FIG. 13) in the actual travel state information at time T+1 is smaller by 3% than the actual travel state value in the actual travel state information at time T. The temporarily set new predicted value is an example of an “index acquired from the actual travel state value.” An effect value which will be described later is an example of an “index acquired from a result value” or an “index based on a result value.”

Then, the predictor 160 calculates an effect value (V7 in FIG. 13) of the result value at time T+2. The effect value is a value acquired from the past tendency of the result value. The effect value is, for example, a value obtained by linearly extending a line connecting the result at time T and the result at time T+1.

The predictor 160 compares the existing predicted value at time T+2 (V5 in FIG. 13) with the effect value (V7 in FIG. 13) of the result value at time T+2, and does not correct the temporarily set new predicted value and sets the existing predicted value as a new predictor value (V5 in FIG. 13) when the existing predicted value is predicted to increase with respect to the effect value of the result value (when a sign of a result of subtraction of the effect value from the existing predicted value is plus).

When the existing predicted value is increased with respect to the result value, a value based on the existing predicted value instead of the existing predicted value may be set as a new predicted value. The value based on the existing predicted value is, for example, a value obtained by correcting the existing predicted value to increase (or decrease). For example, the predictor 160 may determine the new predicted value on the basis of the temporarily set new predicted value (the value obtained by increasing the existing predicted value) and the existing predicted value (the existing predicted value at a third time point) (for example, on the basis of a value based on a difference therebetween).

When the effect value is larger than the existing predicted value (or when both values are equal to or similar to each other), the temporarily set new predicted value (V6 in FIG. 13) may be set as a regular new predicted value or the existing predicted value may be set as a regular new predicted value.

As described above, the predictor 160 determines whether the existing predicted value is to be employed as a new predicted value or whether the value obtained by performing correction based on the actual travel state value thereon is to be employed as a new predicted value using the actual travel state value, the effect value, and the existing predicted value. Accordingly, the demand prediction device 100 can more accurately predict a demand for a component. In the embodiment, the process described above with reference to FIG. 13 may be omitted and the process described above with reference to FIG. 12 may be performed.

The predictor 160 may derive types and numbers of components necessary in the future for each area on the basis of the aforementioned prediction information or may derive the number of ordered components for each area on the basis of the derived numbers of components and the number of inventory components in a predetermined facility (for example, a dealer). Accordingly, the demand prediction device 100 can perform appropriate inventory management for each area.

### Flowchart

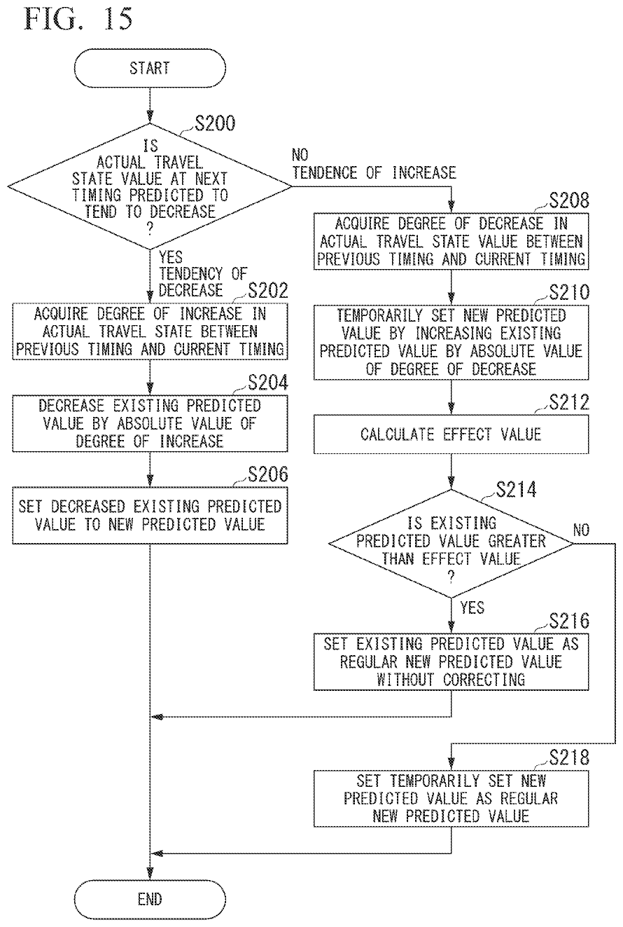

A flow of a series of processes which is performed by the demand prediction device 100 will be described below. FIG. 14 is a flowchart illustrating an example of a process flow which is performed by the demand prediction device 100. In the example illustrated in FIG. 14, the acquirer 140 acquires operation information form vehicles M (Step S100). Then, the acquirer 140 acquires demand result information from a predetermined facility connected to the network NW or a management device or the like managing demand results (Step S102). The process of Step S102 may be performed before the process of Step S100. Then, the estimator 150 acquires position information of a vehicle M included in the operation information and estimates a location of the vehicle M on the basis of the acquired position information (Step S104). Then, the estimator 150 estimates an area (for example, a subarea) to which the vehicle M belongs on the basis of the location of the vehicle M (Step S106). Then, the predictor 160 generates information indicating an actual travel state for each area (Step S108) and generates prediction information on the basis of the generated information indicating an actual travel state (Step S110). Then, the information provider 170 provides the generated prediction information (Step S112). Accordingly, the process flow in the flowchart ends.

A flow of the process of Step S110 which is performed by the predictor 160 will be specifically described below. FIG. 15 is a flowchart illustrating an example of a process flow which is performed by the predictor 160. In the example illustrated in FIG. 15, first, the predictor 160 determines whether an actual travel state value at a next prediction time can be predicted to tend to decrease with respect to the actual travel state value at the current time on the basis of the tendency of the actual travel state values in the past (Step S200).

When it is determined that it is predicted to tend to decrease (YES in Step S200), a second predictor 230 acquires a degree of increase of the current actual travel state value with respect to the previous actual travel state value (Step S202). Then, the predictor 160 decreases the existing predicted value by an absolute value of the degree of increase (Step S204). Then, the second predictor 230 sets the decreased existing predicted value as a new predicted value (Step S206). Accordingly, one routine of the flowchart ends.

When it is determined that it is not predicted to tend to decrease (it is predicted to tend to increase (NO in Step S200)), the predictor 160 acquires a degree of decrease of the current actual travel state value with respect to the previous actual travel state value (Step S208). Then, the predictor 160 temporarily sets a new predicted value by increasing the existing predicted value by an absolute value of the degree of decrease (Step S210). Then, the predictor 160 calculates an effect value on the basis of the result value (Step S212).

Then, the predictor 160 determines whether the existing predicted value increases with respect to the effect value (Step S214). When it is determined that the existing predicted value increases with respect to the effect value, the predictor 160 does not correct the temporarily set new predicted value but sets the existing predicted value as a regular new predicted value (Step S216). When it is determined that the existing predicted value does not increase with respect to the effect value, the predictor 160 sets the temporarily set new predicted value as a regular new predicted value (Step S218). Accordingly, one routine of the flowchart ends.

The order of the processes may be changed, and some processes may be skipped. For example, when an existing predicted value increases with respect to an effect value, the process of temporarily setting a new predicted value may be skipped. In this process, when the existing predicted value decreases with respect to the effect value, the same process as described above may be performed. For example, when the temporarily set new predicted value is smaller than the existing predicted value and the existing predicted value is smaller than the effect value, the predictor 160 may not set the temporarily set new predicted value as a regular new predicted value but may set the existing predicted value as a regular new predicted value.

The demand prediction device 100 may perform the aforementioned processes when a demand for a specific component in a specific area or a specific vehicle model is predicted. For example, the demand prediction device 100 may perform the aforementioned processes when a demand for a component of vehicles in which a vehicle size is equal to or less than a predetermined size, front components, or components for which a demand scale is equal to or greater than a predetermined scale is predicted. This is because prediction accuracy of a vehicle in which a vehicle size is equal to or less than a predetermined size tends to be higher than prediction accuracy of a vehicle in which a vehicle size is greater than the predetermined size, prediction accuracy of front components tends to be higher than prediction accuracy of other components (for example, rear components), and prediction accuracy of components in which a demand scale is equal to or greater than the predetermined scale tends to be higher than prediction accuracy of components in which the demand scale is less than the predetermined scale.

According to the embodiment described above, since the demand prediction device 100 that predicts a future demand for a component of a vehicle M in preparation for replacement or repair of the component includes the position acquirer 146 configured to acquire position information at an operation start time or an operation end time of the vehicle M, the estimator 150 configured to estimate a location of the vehicle M on the basis of the position information acquired by the position acquirer 146, and the predictor 160 configured to predict the future demand for the component in a predetermined area including the location estimated by the estimator 150, it is possible to more accurately predict a future demand for a component of a vehicle.

Specifically, according to the embodiment, it is possible to realize more accurate prediction of a future demand by using information on locations of vehicles for demand prediction with a focus on high interrelation or correlation between a demand proportion of vehicle components and a location proportion of vehicles in each area. According to the embodiment, it is possible to perform demand prediction in consideration of change in a demand target scale due to relocation of users or actual usage of vehicles based on operation/non-operation of the vehicles.

According to the embodiment, it is possible to ascertain change in operation situations in a more timely and detailed manner by acquiring operation information of vehicles M for each area in a predetermined period (for example, a month). According to the embodiment, by setting an average of operation start points or operation end points (latitude and longitude) in a target period as a location of a vehicle in the target period and performing demand prediction based on a variation of a location distribution of vehicles in the area, it is possible to more accurately ascertain a variation in vehicles in each area in more detail and to improve prediction accuracy for each area. According to the embodiment, since different demand prediction can be performed when the location is the home, a workplace, or other places by estimating whether the location is the home or a workplace, it is possible to perform demand prediction in more detail.

According to the embodiment, by providing generated prediction information, it is possible to support component ordering, inventory management, or the like for each area in dealers or the like. For example, consumption factors for each component can be identified on the basis of operation situations of vehicles M, component replacement histories, or the like for each area, and it is possible to more appropriately management an amount of inventory by predicting a next replacement time for each vehicle (or for each vehicle model). According to the embodiment, it is possible to advance delivery dates until a dealer or the like purchases components on the basis of the prediction result and to provide a better service to users.

According to the embodiment, it is possible to ascertain market trends in real time or to perform prediction based on a short time period such as recent three months by using connected data such as operation information acquired from vehicles M. According to the embodiment, it is possible to maintain the whole level of prediction accuracy at a high level by appropriately correcting a predicted value in consideration of an upper limit change ratio derived from vehicle travel shifts. According to the embodiment, it is possible to realize more accurate prediction of a future demand by using information on locations of vehicles for demand prediction with a focus on high interrelation or correlation between a demand proportion of vehicle components and a location proportion of vehicles in each area.

While an embodiment of the present invention has been described above, the present invention is not limited thereto and can be subjected to various modifications or substitutions without departing from the gist of the present invention.

1. A demand prediction device that predicts a future demand for a component of a vehicle in preparation for replacement or repair of the component, the demand prediction device comprising:
a position acquirer configured to acquire position information at an operation start time or an operation end time of the vehicle;
an estimator configured to estimate a location of the vehicle on the basis of the position information acquired by the position acquirer; and
a predictor configured to predict a future demand for the component in a predetermined area including the location estimated by the estimator.

2. The demand prediction device according to claim 1, wherein the estimator estimates the location of the vehicle on the basis of a time at which the position information is acquired by the position acquirer and the number of acquisitions.

3. The demand prediction device according to claim 2, wherein the estimator estimates the home or a workplace of a user of the vehicle on the basis of a time period correlated with the position information.

4. The demand prediction device according to claim 3, wherein the estimator estimates the home on the basis of the position information when the position information is acquired a predetermined number of times or more by the position acquirer in a first time period and estimates the workplace on the basis of the position information when the position information is acquired a predetermined number of times or more in a second time period later than the first time period.

5. The demand prediction device according to claim 1, wherein the position acquirer acquires the position information from each of a plurality of vehicles,
wherein the estimator estimates a location distribution of the plurality of vehicles in a predetermined period on the basis of the position information of the plurality of vehicles, and
wherein the predictor predicts a future demand for the component for each predetermined area on the basis of the location distribution estimated by the estimator.

6. The demand prediction device according to claim 5, further comprising:
a demand result acquirer configured to acquire demand result information of the component for each predetermined area; and
an operation information acquirer configured to acquire vehicle operation information from vehicles belonging to the predetermined area,
wherein the predictor predicts a future demand for the component for each predetermined area on the basis of tendencies of increase or decrease and fluctuation of a value based on the operation information in a time series and tendencies of increase or decrease and fluctuation of a result value based on the demand result information.

7. The demand prediction device according to claim 6, wherein the predictor predicts the demand at a third time point later than a first time point on the basis of a result value based on the demand result information for every predetermined period in a time series and an operation value based on the operation information and on the basis of a shift between the operation value at the first time point and the operation value at a second time point earlier than the first time point.

8. The demand prediction device according to claim 7, wherein the predictor sets a predicted value of the demand at the third time point to be lower than an existing predicted value calculated in advance when the operation value at the first time point tends to increase with respect to the operation value at the second time point and sets the predicted value at the third time point to be higher than the existing predicted value calculated in advance when the operation value at the first time point tends to decrease with respect to the operation value at the second time point.

9. A demand prediction method that is performed by a computer of a demand prediction device for predicting a future demand for a component of a vehicle in preparation for replacement or repair of the component, the demand prediction method comprising:
acquiring position information at an operation start time or an operation end time of the vehicle;
estimating a location of the vehicle on the basis of the acquired position information; and
predicting a future demand for the component in a predetermined area including the estimated location.

10. A storage medium storing a program, the program causing a computer of a demand prediction device for predicting a future demand for a component of a vehicle in preparation for replacement or repair of the component to perform:
acquiring position information at an operation start time or an operation end time of the vehicle;
estimating a location of the vehicle on the basis of the acquired position information; and
predicting a future demand for the component in a predetermined area including the estimated location.
